(19) United States
(12) Patent Application Publication
(10) Pub. No.: US 2013/0173827 A1
(43) Pub. Date: Jul. 4, 2013

(54) METHOD, DEVICE, AND SYSTEM FOR STARTING PLUG-IN TYPE APPARATUS

(71) Applicant: Huawei Technologies Co., Ltd., Shenzhen (CN)

(72) Inventors: Jiangxiong LI, Shanghai (CN); Yang ZONG, Shanghai (CN); Jun ZHU, Shanghai (CN)

(73) Assignee: HUAWEI TECHNOLOGIES CO., LTD., Shenzhen (CN)

(21) Appl. No.: 13/717,337

(22) Filed: Dec. 17, 2012

(30) Foreign Application Priority Data
Dec. 16, 2011 (CN) 201110424180.2

(51) Int. Cl. G06F 11/30

(52) U.S. Cl. CPC G06F 11/3041
USPC 710/5

(57) ABSTRACT

Embodiments of the present invention disclose a method, a device, and a system for starting a plug-in type apparatus. In the embodiments of the present invention, the method includes: receiving an inquiry command sent by a host; determining, according to the inquiry command, whether a plug-in type apparatus exists; when the plug-in type apparatus does not exist, sending a media change command to the host; and when the plug-in type apparatus exists, sending a media ok command to the host, so that the plug-in type apparatus performs data exchange with the host. With the solution, not only a compatibility problem of the plug-in type apparatus may be alleviated and an identification rate of the plug-in type apparatus may be improved, but also startup time of the plug-in type apparatus may be shortened greatly.

### CROSS-REFERENCE TO RELATED APPLICATIONS

This application claims priority to Chinese Patent Application No. 201110424180.2, filed on Dec. 16, 2011, which is hereby incorporated by reference in its entirety.

### FIELD OF THE INVENTION

The present invention relates to the field of communications, and in particular, to a method, a device, and a system for starting a plug-in type apparatus.

### BACKGROUND OF THE INVENTION

With rapid development of communications technologies, a plug-in type apparatus is applied more widely. In the prior art, when a plug-in type apparatus is inserted in a communication apparatus, such as a personal computer (PC, Personal Computer), a host of the PC (hereinafter referred to as a host) first performs detection identification on the plug-in type apparatus. If the detection identification is normal, the host sends an inquiry command to a driving device to poll whether the plug-in type apparatus exists. When the plug-in type apparatus does not exist, the driving device sends a no media (no media) command to the host. Subsequently, the host continues to send an inquiry command to the driving device. When the plug-in type apparatus exists, in order to ensure that another apparatus in the host can also complete preparation, at this time, the driving device also sends a no media command to the host at least once, and then sends a media ok (media ok) command to the host, so that the plug-in type apparatus can subsequently perform data exchange with the host.

In a study and practice process of the prior art, the inventor of the present invention finds that, in an existing method for starting a plug-in type apparatus, even if a driving device polls that a plug-in type apparatus exists, the driving device still sends a no media command to a host for a plurality of times first, and then sends a media ok command to the host, so as to perform a subsequent operation. Therefore, startup time of a conventional plug-in type apparatus is long. In addition, in a process of a compatibility test on the plug-in type apparatus, the inventor finds that sending a no media command may cause a compatibility problem, thereby affecting an identification rate of the plug-in type apparatus.

### SUMMARY OF THE INVENTION

Embodiments of the present invention provide a method, a device, and a system for starting a plug-in type apparatus, so that startup time of an apparatus may be shortened and an identification rate of the apparatus may be improved.

A method for starting a plug-in type apparatus includes:

receiving an inquiry command sent by a host, where the inquiry command is used to inquire whether a plug-in type apparatus exists;

determining, according to the inquiry command, whether the plug-in type apparatus exists;

when the plug-in type apparatus does not exist, sending a media change (media change) command to the host, where the media change command is used to notify the host that the plug-in type apparatus does not exist currently; and

when the plug-in type apparatus exists, sending a media ok command to the host, where the media ok command is used to notify the host that the plug-in type apparatus exists currently, so that the plug-in type apparatus performs data exchange with the host.

A method for starting a plug-in type apparatus includes:

sending an inquiry command, so as to trigger a driving device, to determine whether a plug-in type apparatus exists, where the inquiry command is used to inquire whether the plug-in type apparatus exists;

when the plug-in type apparatus does not exist, receiving a media change command sent by the driving device, where the media change command indicates that the plug-in type apparatus does not exist currently; and

when the plug-in type apparatus exists, receiving a media ok command sent by the driving device, and performing data exchange with the plug-in type apparatus, where the media ok command indicates that the plug-in type apparatus exists currently.

A driving device includes:

a receiving unit, configured to receive an inquiry command sent by a host, where the inquiry command is used to inquire whether a plug-in type apparatus exists;

a determining unit, configured to determine, according to the inquiry command received by the receiving unit, whether the plug-in type apparatus exists; and

a processing unit, configured to send a media ok command to the host when the determining unit determines that the plug-in type apparatus exists, where the media ok command is used to notify the host that the plug-in type apparatus exists currently, so that the plug-in type apparatus performs data exchange with the host; and send a media change command to the host when the determining unit determines that the plug-in type apparatus does not exist, where the media change command is used to notify the host that the plug-in type apparatus does not exist currently.

A communication apparatus includes:

a sending unit, configured to send an inquiry command, so as to trigger a driving device, to determine whether a plug-in type apparatus exists, where the inquiry command is used to inquire whether the plug-in type apparatus exists; and

a processing unit, configured to, when the driving device determines that the plug-in type apparatus does not exist, receive a media change command sent by the driving device, where the media change command indicates that the plug-in type apparatus does not exist currently; and when the driving device determines that the plug-in type apparatus exists, receive a media ok command sent by the driving device and perform data exchange with the plug-in type apparatus, where the media ok command indicates that the plug-in type apparatus exists currently.

A communication system includes any one driving device and any one communication apparatus that are provided in the embodiments of the present invention.

It can be seen from the foregoing technical solutions that, the embodiments of the present invention have the following advantages.

In the embodiments of the present invention, after receiving an inquiry command sent by a host, when a plug-in type apparatus does not exist, the plug-in type apparatus sends a media change command to the host rather than sends a no media command, and therefore, a compatibility problem of the plug-in type apparatus may be alleviated and an identification rate of the apparatus may be improved. Furthermore, when the plug-in type apparatus exists, the plug-in type apparatus directly sends a media ok command to the host without sending a no media command to the host for a plurality of times, and therefore, startup time of the plug-in type apparatus may be shortened greatly.

### BRIEF DESCRIPTION OF THE DRAWINGS

To illustrate the technical solutions in the embodiments of the present invention more clearly, the accompanying drawings required for describing the embodiments are introduced briefly in the following. Apparently, the accompanying drawings in the following description merely show some embodiments of the present invention, and persons of skill in the art may also derive other drawings from these accompanying drawings without creative efforts.

FIG. 1 is a schematic flow chart of a method for starting a plug-in type apparatus according to an embodiment of the present invention;

FIG. 2 is another schematic flow chart of a method for starting a plug-in type apparatus according to an embodiment of the present invention;

FIG. 3 is another schematic flow chart of a method for starting a plug-in type apparatus according to an embodiment of the present invention;

FIG. 4 is a schematic structural diagram of a driving device according to an embodiment of the present invention;

FIG. 5 is another schematic structural diagram of a driving device according to an embodiment of the present invention;

FIG. 6 is a schematic structural diagram of a communication apparatus according to an embodiment of the present invention;

FIG. 7 is another schematic structural diagram of a communication apparatus according to an embodiment of the present invention; and

FIG. 8 is a schematic structural diagram of a communication system according to an embodiment of the present invention.

### DETAILED DESCRIPTION OF THE EMBODIMENTS

The technical solutions in the embodiments of the present invention are clearly and completely described in the following with reference to the accompanying drawings in the embodiments of the present invention. Apparently, the embodiments in the following description are merely a part rather than all of the embodiments of the present invention. Based on the embodiments of the present invention, all other embodiments obtained by persons of ordinary skill in the art without creative efforts shall fall within the protection scope of the present invention.

An embodiment of the present invention provides a method for starting a plug-in type apparatus, so that startup time of an apparatus may be shortened and an identification rate of the apparatus may be improved. Embodiments of the present invention further provide a corresponding driving device, a corresponding communication apparatus, and a corresponding communication system, which are described in detail in the following respectively.

### Embodiment 1

In this embodiment, the description is made from the perspective of a driving device (Device) of a plug-in type apparatus. In order to facilitate the description, the driving device of the plug-in type apparatus is referred to as a driving device. In this embodiment, the driving device may exist in the form of a universal serial bus (USB, Universal Serial Bus) compact disc read-only memory (CDROM, Compact Disc Read-Only Memory). Moreover, the plug-in type apparatus may specifically be a USB apparatus.

A method for starting a plug-in type apparatus includes: receiving an inquiry command sent by a host; determining, according to the inquiry command, whether a plug-in type apparatus exists, when the plug-in type apparatus does not exist, sending a media change command to the host, where the media change command is used to notify the host that the plug-in type apparatus does not exist currently, and when the plug-in type apparatus exists, sending a media ok command to the host, where the media ok command is used to notify the host that the plug-in type apparatus exists currently, so that the plug-in type apparatus performs data exchange with the host.

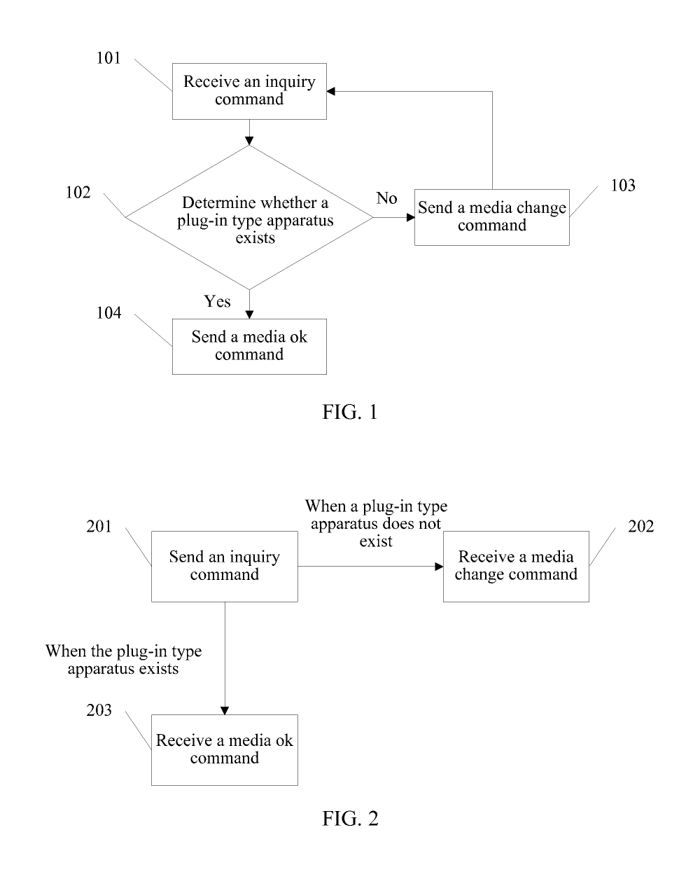

As shown in FIG. 1, a specific procedure may be as follows:

101: Receive an inquiry command sent by a host, for example, which may be as follows specifically.

When a plug-in type apparatus is inserted in a host, the host sends an inquiry command to a driving device, where the inquiry command is used to inquire whether the plug-in type apparatus exists.

When the plug-in type apparatus is inserted in the host, the host may be incapable of identifying existence of the plug-in type apparatus for a variety of reasons, or it takes some time before the host can identify the existence of the plug-in type apparatus. For example, for a reason such as poor interface contact, the host may be incapable of identifying the existence of the plug-in type apparatus. Therefore, the host needs to send an inquiry command to the driving device at this time to perform inquiry on the plug-in type apparatus, so as to determine whether the plug-in type apparatus has been identified and can be used normally.

It should be noted that, before receiving an inquiry command sent by the host, the driving device further needs to accept detection identification of the host first. The host performs detection identification on the plug-in type apparatus, and mainly performs identification on an apparatus form of the plug-in type apparatus. In this embodiment, after being connected to the host, the plug-in type apparatus may be virtualized to a plurality of apparatus forms. For example, when the plug-in type apparatus is a USB apparatus, the plug-in type apparatus may be virtualized to apparatus forms such as a USB flash disk, a USB virtual serial port, a USB virtual network card, and a USB virtualizer. The apparatus form of the plug-in type apparatus may be obtained precisely by performing detection identification on the plug-in type apparatus.

102: Determine, according to the received inquiry command, whether a plug-in type apparatus exists. If the plug-in type apparatus does not exist, perform step 103. If the plug-in type apparatus exists, perform step 104.

For a relevant method for determining whether a plug-in type apparatus exists, reference may be made to the prior art, which is not described again herein.

103: When the plug-in type apparatus does not exist, send a media change command to the host. At this time, step 101 may also be returned back and performed, that is, continue to receive an inquiry command sent by the host, so as to poll whether the plug-in type apparatus exists, for example, which may be as follows specifically.

When the driving device determines that the plug-in type apparatus does not exist, the driving device sends to the host a media change command, which indicates that the apparatus form of the plug-in type apparatus changes.

After receiving the media change command, the host continues to send an inquiry command to the driving device, so as to re-determine whether the plug-in type apparatus exists.

In order to prevent an inquiry process from lasting for an excessively long time, save a signaling procedure, and improve efficiency, the number of times for sending an inquiry command by the host may be defined according to a requirement of an actual application. For example, the number of the repeated inquiry may be defined as 3. When the driving device determines that the plug-in type apparatus does not exist, step 101 is returned back and performed, that is, continue to receive an inquiry command sent by the host. If the plug-in type apparatus does not exist when the inquiry is performed three times successively, the procedure is ended.

Through a compatibility test of the plug-in type apparatus in practice, it is found that, with respect to a no media command, one interaction process of sending a media change command to the host by the driving device takes a longer time. Therefore, in order to achieve an equal time span, the number of times for sending a media change command is smaller than the number of times for sending a no media command. Therefore, as compared with the interaction process of sending a no media command, sending a media change command has better compatibility, which is useful for improving an identification rate of the plug-in type apparatus.

104: When the plug-in type apparatus exists, send a media ok command to the host, so that the plug-in type apparatus performs data exchange with the host, for example, which may be as follows specifically.

When the driving device determines that the plug-in type apparatus exists, the driving device may directly send to the host a media ok command, which indicates that the plug-in type apparatus has completed preparation, and can perform data exchange with the host at any time.

After receiving the media ok command, the host may perform data exchange with the plug-in type apparatus.

In addition, it should be noted that, in order to ensure that another apparatus in the host can also complete preparation at this time, so that a subsequent operation can be performed normally, before the media ok command is sent to the host, a media change command may also be sent to the host, so as to ensure that another apparatus in the host has sufficient time for preparation. That is, before step “send a media ok command to the host”, the method may further include:

Send a media change command to the host once.

It can be known from the foregoing that, in the technical solution of this embodiment, when a plug-in type apparatus does not exist, a driving device sends a media change command to a host rather than sends a no media command, and therefore, a compatibility problem of the plug-in type apparatus may be alleviated and an identification rate of the plug-in type apparatus may be improved. Furthermore, when the plug-in type apparatus exists, the driving device directly sends a media ok command to the host without sending a no media command to the host for a plurality of times, and therefore, startup time of the plug-in type apparatus may be shortened greatly.

### Embodiment 2

In this embodiment, the description is made from the perspective of a host.

A method for starting a plug-in type apparatus includes: sending an inquiry command, so as to trigger a driving device, to determine whether a plug-in type apparatus exists; when the plug-in type apparatus does not exist, receiving a media change command sent by the driving device, where the media change command indicates that the plug-in type apparatus does not exist currently; and when the plug-in type apparatus exists, receiving a media ok command sent by the driving device, and performing data exchange with the plug-in type apparatus, where the media ok command indicates that the plug-in type apparatus exists currently.

As shown in FIG. 2, a specific procedure may be as follows.

201: Send an inquiry command, so as to trigger a driving device, to determine whether a plug-in type apparatus exists, for example, which may be as follows specifically.

When a plug-in type apparatus is inserted in a host, the host sends an inquiry command to a driving device, where the inquiry command is used to inquire whether the plug-in type apparatus exists. After receiving the inquiry command, the driving device determines, according to the inquiry command, whether the plug-in type apparatus exists. Reference may be made to Embodiment 1 for details, which is not described again herein.

When the plug-in type apparatus is inserted in the host, the host may be incapable of identifying existence of the plug-in type apparatus for a variety of reasons, or it takes some time before the host can identify the existence of the plug-in type apparatus. For example, for a reason such as poor interface contact, the host may be incapable of identifying the existence of the plug-in type apparatus. Therefore, the host needs to send an inquiry command to the driving device at this time to perform inquiry on the plug-in type apparatus, so as to determine whether the plug-in type apparatus can be identified and can be used normally.

It should be noted that, before sending an inquiry command to the plug-in type apparatus, the host further needs to perform detection identification on the plug-in type apparatus first. The host performs detection identification on the plug-in type apparatus, and mainly performs identification on an apparatus form of the plug-in type apparatus. After being connected to the host, the plug-in type apparatus may be virtualized to a plurality of apparatus forms. For example, when the plug-in type apparatus is a USB apparatus, the plug-in type apparatus may be virtualized to apparatus forms such as a USB flash disk, a USB virtual serial port, a USB virtual network card, and a USB virtualizer. The apparatus form of the plug-in type apparatus may be obtained precisely by performing detection identification on the plug-in type apparatus.

202: Receive a media change command sent by the driving device. If it is determined that the plug-in type apparatus does not exist, at this time, step 201 may also be returned back and performed, that is, continue to send an inquiry command, so as to trigger the driving device, to determine whether the plug-in type apparatus exists, which may be as follows specifically.

The host receives a media change command sent by the driving device. The media change command indicates that the apparatus form of the plug-in type apparatus changes.

After receiving the media change command, the host determines that the plug-in type apparatus does not exist. At this time, the host may continue to send an inquiry command to the driving device, so as to re-determine whether the plug-in type apparatus exists.

In order to prevent an inquiry process from lasting for an excessively long time, save a signaling procedure, and improve efficiency, the number of times for sending an inquiry command by the host may be defined according to a requirement of an actual application. For example, the number of the repeated inquiry may be defined as 3. When the media change command returned by the driving device is received, step 201 is returned back and performed, that is, continue to send an inquiry command. If the media change command is received when the inquiry is performed three times successively, the procedure is ended.

Through a compatibility test of the plug-in type apparatus in practice, it is found that, with respect to a no media command, one interaction process of sending a media change command to the host by the driving device takes a longer time. Therefore, in order to achieve an equal time span, the number of times for sending a media change command is smaller than the number of times for sending a no media command. Therefore, as compared with the interaction process of sending a no media command, sending a media change command has better compatibility, which is useful for improving an identification rate of the plug-in type apparatus.

203: Receive a media ok command sent by the driving device, determine that the plug-in type apparatus exists, and perform data exchange with the plug-in type apparatus, for example, which may be as follows specifically.

The host receives a media ok command sent by the driving device. The media ok command indicates that the plug-in type apparatus has completed preparation, and can perform data exchange with the host at any time.

After receiving the media ok command, the host determines that the plug-in type apparatus exists, that is, can perform data exchange with the plug-in type apparatus.

It can be known from the foregoing that, in the technical solution of this embodiment, when a plug-in type apparatus does not exist, a host receives a media change command sent by a driving device rather than receives a no media command, and therefore, a compatibility problem of the plug-in type apparatus may be alleviated and an identification rate of the plug-in type apparatus may be improved. Furthermore, when the plug-in type apparatus exists, the host directly receives a media ok command sent by the driving device without receiving a no media command sent by the driving device for a plurality of times, and therefore, startup time of the plug-in type apparatus may be shortened greatly.

### Embodiment 3

In this embodiment, the technical solution is described in combination with a driving device of a plug-in type apparatus and a host. In order to facilitate the description, the driving device of the plug-in type apparatus is referred to as a driving device. The driving device may exist specifically in the form of a USB CDROM. Moreover, the plug-in type apparatus may specifically be a USB apparatus. In order to facilitate the description, that the plug-in type apparatus is specifically a USB apparatus is taken as an example for description in the following.

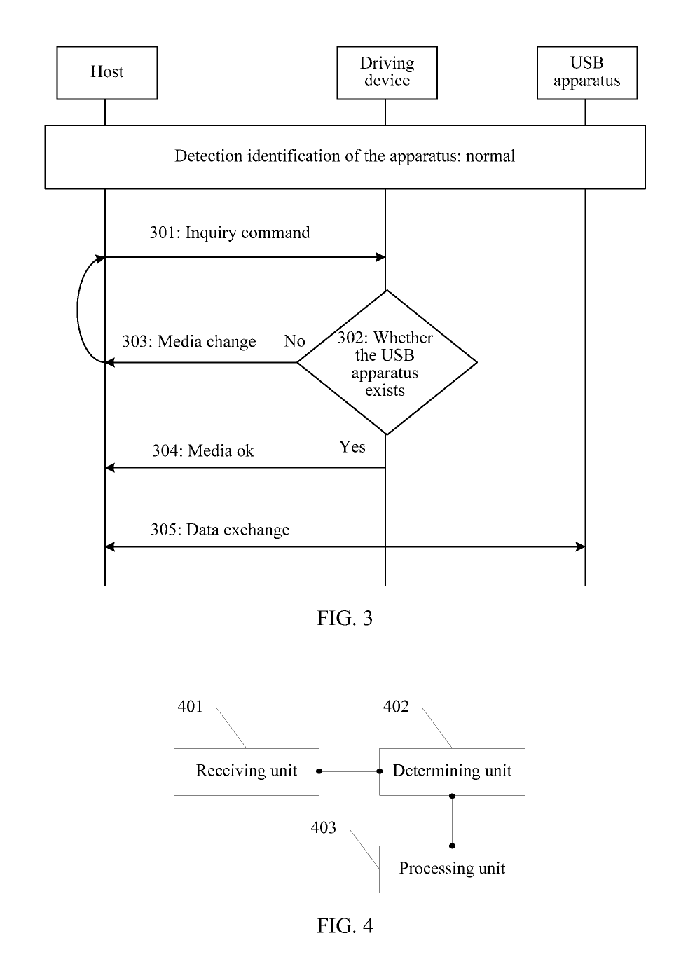

As shown in FIG. 3, a specific procedure of a method for starting a plug-in type apparatus may be as follows.

301: When a USB apparatus is inserted in a host, the host sends an inquiry command to a driving device, where the inquiry command is used to poll whether the USB apparatus exists.

It should be noted that, before sending the inquiry command to the driving device, the host may further perform detection identification on the USB apparatus first. After the driving device is started by a USB that has a ROM function, a process of detection identification on the USB apparatus is completed through a hardware signal change between the host and the driving device. Only after detection identification of the USB apparatus is normal, the host sends the inquiry command to the driving device. The host performs detection identification on the USB apparatus, and mainly performs identification on an apparatus form of the USB apparatus. Reference may be made to the prior art for details, which is not described again herein.

302: After receiving the inquiry command sent by the host, the driving device determines whether the USB apparatus exists. If the USB apparatus does not exist, perform step 303. If the USB apparatus exists, perform step 304.

For a relevant method for the driving device to determine whether a USB apparatus exists, reference may be made to the prior art, which is not described again herein.

303: When the USB apparatus does not exist, the driving device sends a media change command to the host; and step 301 is returned back and performed, that is, the host continues to send an inquiry command to the driving device, so as to re-determine whether the USB apparatus exists.

In order to prevent an inquiry process from lasting for an excessively long time, save a signaling procedure, and improve efficiency, the number of times for sending an inquiry command by the host may be defined according to a requirement of an actual application. For example, the number of the repeated inquiry may be defined as 3. When the driving device determines that the USB apparatus does not exist, the host continues to send an inquiry command to the driving device. If the USB apparatus does not exist when the inquiry is performed three times successively, the procedure is ended.

304: When the plug-in type apparatus exists, the driving device directly sends to the host a media ok command, which indicates that the USB apparatus has completed preparation, and can perform data exchange with the host at any time.

305: After receiving the media ok command sent by the driving device, the host may perform data exchange with the USB apparatus.

In addition, it should be noted that, in order to ensure that another apparatus in the host can also complete preparation at this time, so that a subsequent operation can be performed normally, before sending the media ok command to the host (that is, before step 304), the driving device may further send a media change command to the host, so as to ensure that another apparatus in the host has sufficient time for preparation.

It can be known from the foregoing that, in the technical solution of this embodiment, when a plug-in type apparatus does not exist, a driving device sends a media change command to a host rather than sends a no media command, and therefore, a compatibility problem of the plug-in type apparatus may be alleviated and an identification rate of the plug-in type apparatus may be improved. Furthermore, when the plug-in type apparatus exists, the driving device directly sends a media ok command to the host without sending a no media command to the host for a plurality of times, and therefore, startup time of the plug-in type apparatus may be shortened greatly.

### Embodiment 4

In order to better implement the foregoing method, an embodiment of the present invention further provides a driving device as a driving device of a plug-in type apparatus (that is, Device, referred to as a driving device). As shown in FIG. 4, the driving device may specifically include a receiving unit 401, a determining unit 402, and a processing unit 403.

The receiving unit 401 is configured to receive an inquiry command sent by a host, where the inquiry command is used to inquire whether a plug-in type apparatus exists.

The determining unit 402 is configured to determine, according to the inquiry command received by the receiving unit 401, whether the plug-in type apparatus exists.

The processing unit 403 is configured to send a media ok command to the host when the determining unit 402 determines that the plug-in type apparatus exists, so that the plug-in type apparatus performs data exchange with the host; and send a media change command to the host when the determining unit 402 determines that the plug-in type apparatus does not exist. The media ok command is used to notify the host that the plug-in type apparatus exists currently, and the media change command is used to notify the host that the plug-in type apparatus does not exist currently.

In addition, the processing unit 403 is further configured to, after sending the media change command to the host, trigger the receiving unit 401, to continue to receive an inquiry command sent by the host.

It should be noted that, in order to ensure that another apparatus in the host can also complete preparation at this time, so that a subsequent operation can be performed normally, before sending the media ok command to the host, the processing unit 403 may further send a media change command to the host once, so as to ensure that another apparatus in the host has sufficient time for preparation. That is:

The processing unit 403 may further be configured to, when the determining unit 402 determines that the plug-in type apparatus exists, send a media change command to the host once, and then send a media ok command to the host.

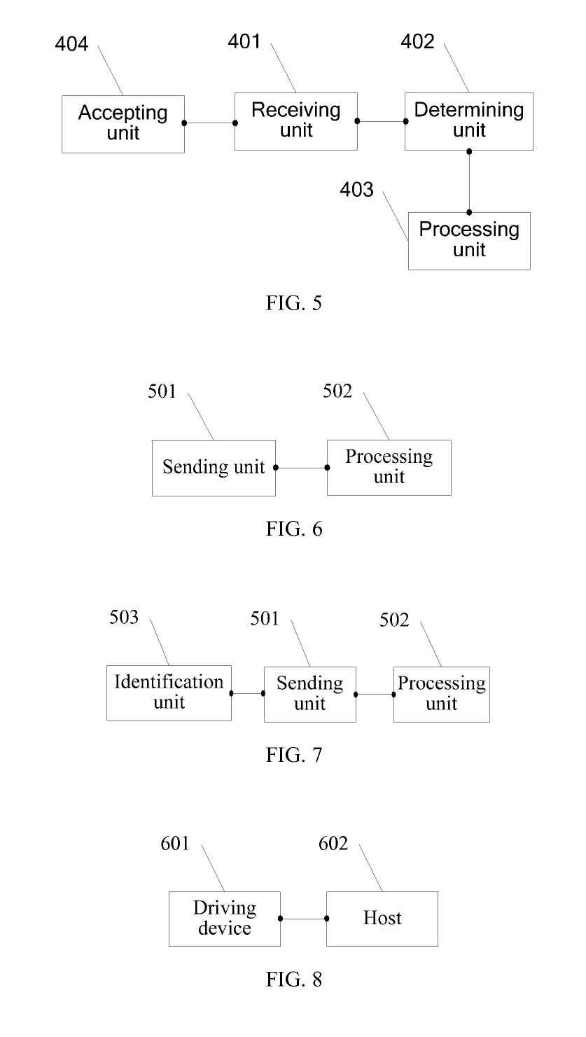

It should be noted that, after being connected to the host, the plug-in type apparatus may be virtualized to a plurality of apparatus forms. For example, when the plug-in type apparatus is a USB apparatus, the plug-in type apparatus may be virtualized to apparatus forms such as a USB flash disk, a USB virtual serial port, a USB virtual network card, and a USB virtualizer. Therefore, in order to determine an apparatus form of the plug-in type apparatus, before receiving the inquiry command sent by the host, the driving device may further accept detection identification of the host, so as to precisely obtain an apparatus form of the plug-in type apparatus. That is, as shown in FIG. 5, in this embodiment of the present invention, the driving device may further include an accepting unit 404.

The accepting unit 404 is configured to accept detection identification of the host, so as to obtain an apparatus form of the plug-in type apparatus when the plug-in type apparatus is started.

The driving device may exist specifically in the form of a USB CDROM. In specific implementation, each of the foregoing units may serve as independent entities to be implemented, and may also be arbitrarily combined and serve as the same entity or several entities to be implemented. For the specific implementation of each of the foregoing units, reference may be made to the foregoing method embodiments, which is not described again herein.

It can be known from the foregoing that, in this embodiment of the present invention, when a plug-in type apparatus does not exist, a processing unit 403 sends a media change command to a host rather than sends a no media command, and therefore, a compatibility problem of the plug-in type apparatus may be alleviated and an identification rate of the plug-in type apparatus may be improved. Furthermore, when the plug-in type apparatus exists, the processing unit 403 directly sends a media ok command to the host without sending a no media command to the host for a plurality of times, and therefore, startup time of the plug-in type apparatus may be shortened greatly.

### Embodiment 5

Accordingly, an embodiment of the present invention further provides a communication apparatus, which may serve as a host in this embodiment of the present invention. Referring to FIG. 6, the communication apparatus may specifically include a sending unit 501 and a processing unit 502.

The sending unit 501 is configured to send an inquiry command, so as to trigger a driving device, to determine whether a plug-in type apparatus exists, where the inquiry command is used to inquire whether the plug-in type apparatus exists.

The processing unit 502 is configured to, when the driving device determines that the plug-in type apparatus does not exist, receive a media change command sent by the driving device, where the media change command indicates that the plug-in type apparatus does not exist currently; and when the driving device determines that the plug-in type apparatus exists, receive a media ok command sent by the driving device and perform data exchange with the plug-in type apparatus, where the media ok command indicates that the plug-in type apparatus exists currently.

In addition, the processing unit 502 is further configured to, after receiving the media change command sent by the driving device, trigger the sending unit 501, to continue to send an inquiry command, so as to poll whether the plug-in type apparatus exists.

It should be noted that, after being connected to the host, the plug-in type apparatus may be virtualized to a plurality of apparatus forms. For example, when the plug-in type apparatus is a USB apparatus, the plug-in type apparatus may be virtualized to apparatus forms such as a USB flash disk, a USB virtual serial port, a USB virtual network card, and a USB virtualizer. Therefore, in order to determine an apparatus form of the plug-in type apparatus, before the inquiry command is sent, detection identification may further be performed on the plug-in type apparatus, so as to precisely obtain an apparatus form of the plug-in type apparatus. That is, as shown in FIG. 7, the communication apparatus may further include an identification unit 503.

The identification unit 503 is configured to perform detection identification on the plug-in type apparatus, so as to obtain an apparatus form of the plug-in type apparatus when the plug-in type apparatus is started.

At this time, the sending unit 501 is specifically configured to, after the identification unit 503 performs detection identification on the plug-in type apparatus, send the inquiry command to the driving device.

In specific implementation, each of the foregoing units may serve as independent entities to be implemented, and may also be arbitrarily combined and serve as the same entity or several entities to be implemented. For the specific implementation of each of the foregoing units, reference may be made to the foregoing method embodiments, which is not described again herein.

It can be known from the foregoing that, in this embodiment of the present invention, when a plug-in type apparatus does not exist, a processing unit 502 receives a media change command sent by a driving device rather than receives a no media command sent by the driving device, and therefore, a compatibility problem of the plug-in type apparatus may be alleviated and an identification rate of the plug-in type apparatus may be improved. Furthermore, when the plug-in type apparatus exists, the processing unit 502 directly receives a media ok command sent by the driving device without receiving a no media command sent by the driving device for a plurality of times, and therefore, startup time of the plug-in type apparatus may be shortened greatly.

### Embodiment 6

Accordingly, an embodiment of the present invention further provides a communication system. The communication system may specifically include a driving device and a communication apparatus.

In this embodiment, reference may be made to the description in Embodiment 4 for details of the driving device in the communication system, and reference may be made to the description in Embodiment 5 for details of the communication apparatus in the communication system, which are not described again herein.

In this embodiment, the communication apparatus may specifically be a host. For example, referring to FIG. 8, the communication system may specifically include a driving device 601 and a host 602.

The driving device 601 is configured to receive an inquiry command sent by the host 602, determine, according to the inquiry command, whether a plug-in type apparatus exists, send a media change command to the host 602 when the plug-in type apparatus does not exist, and send a media ok command to the host 602 when the plug-in type apparatus exists.

The host 602 is configured to send the inquiry command to the driving device 601, so as to trigger the driving device 601, to determine whether the plug-in type apparatus exists, when the plug-in type apparatus does not exist, receive the media change command sent by the driving device 601, and when the plug-in type apparatus exists, receive the media ok command sent by the driving device 601 and perform data exchange with the plug-in type apparatus.

An execution procedure of the communication system is briefly described in the following.

Step 1: When a plug-in type apparatus is inserted in the host 602, the host 602 sends an inquiry command to the driving device 601, where the inquiry command is used to poll whether the plug-in type apparatus exists.

It should be noted that, before sending the inquiry command to the driving device 601, the host 602 further needs to perform detection identification on the plug-in type apparatus first. A process of detection identification on the plug-in type apparatus may be completed through a hardware signal change between the host 602 and the driving device 601. The host 602 performs detection identification on the plug-in type apparatus, and mainly performs identification on an apparatus form of the plug-in type apparatus. Reference may be made to the prior art for details, which is not described again herein.

Step 2: After receiving the inquiry command sent by the host 602, the driving device 601 determines whether the plug-in type apparatus exists. If the plug-in type apparatus does not exist, perform step 3. If the plug-in type apparatus exists, perform step 4.

For a relevant method for the driving device to determine whether a USB apparatus exists, reference may be made to the prior art, which is not described again herein.

Step 3: When the USB apparatus does not exist, the driving device 601 sends a media change command to the host 602; and step 1 is returned back and performed, that is, the host 602 continues to send an inquiry command to the driving device 601, so as to re-determine whether the USB apparatus exists.

Step 4: When the plug-in type apparatus exists, the driving device 601 directly sends to the host 602 a media ok command, which indicates that the USB apparatus has completed preparation, and can perform data exchange with the host 602 at any time.

Step 5: After receiving the media ok command sent by the driving device 601, the host 602 may perform data exchange with the USB apparatus.

In addition, it should be noted that, in order to ensure that another apparatus in the host 602 can also complete preparation at this time, so that a subsequent operation can be performed normally, before sending the media ok command to the host 602 (that is, before step 4), the driving device 601 may further send a media change command to the host 602, so as to ensure that another apparatus in the host 602 has sufficient time for preparation.

Reference may be made to the foregoing embodiments for specific implementation of each apparatus, which is not described again herein.

It can be known from the foregoing that, in this embodiment of the present invention, when a plug-in type apparatus does not exist, a driving device may send a media change command to a communication apparatus which serves as a host, rather than send a no media command, and therefore, a compatibility problem of the plug-in type apparatus may be alleviated and an identification rate of the plug-in type apparatus may be improved. When the plug-in type apparatus exists, the driving device directly sends a media ok command to the communication apparatus without sending a no media command to the communication apparatus for a plurality of times, where the communication apparatus serves as the host, and therefore, startup time of the plug-in type apparatus may be shortened greatly.

Persons of ordinary skill in the art may understand that all or part of steps of the method according to the embodiments may be implemented by a program instructing relevant hardware. The program may be stored in a computer readable storage medium, and the storage medium may be a read-only memory, a magnetic disk, or an optical disk, and so on.

The method, the device, and the system for starting a plug-in type apparatus provided in the present invention are described in detail in the foregoing. The principle and implementation manner of the present invention are described through specific examples in this specification. The description of the foregoing embodiments is merely provided for helping understand the methods and core ideas of the present invention. Meanwhile, persons of ordinary skill in the art may make variations to the specific implementation manner and the application scope according to the ideas of the embodiments of the present invention. In conclusion, the contents of the specification shall not be construed as a limitation to the present invention.

What is claimed is:

1. A method for starting a plug-in type apparatus, comprising:
receiving an inquiry command sent by a host, wherein the inquiry command is used to inquire whether a plug-in type apparatus exists;
determining, according to the inquiry command, whether the plug-in type apparatus exists;
when the plug-in type apparatus does not exist, sending a media change command to the host, wherein the media change command is used to notify the host that the plug-in type apparatus does not exist currently; and
when the plug-in type apparatus exists, sending a media ok command to the host, wherein the media ok command is used to notify the host that the plug-in type apparatus exists currently, so that the plug-in type apparatus performs data exchange with the host.

2. The method according to claim 1, wherein before the receiving the inquiry command sent by the host, the method further comprises:
accepting detection identification of the host.

3. The method according to claim 1, wherein before the sending the media ok command to the host, the method further comprises:
sending a media change command to the host once.

4. A method for starting a plug-in type apparatus, comprising:
sending an inquiry command, so as to trigger a driving device, to determine whether a plug-in type apparatus exists, wherein the inquiry command is used to inquire whether the plug-in type apparatus exists;
when the plug-in type apparatus does not exist, receiving a media change command sent by the driving device, wherein the media change command indicates that the plug-in type apparatus does not exist currently; and
when the plug-in type apparatus exists, receiving a media ok command sent by the driving device, and performing data exchange with the plug-in type apparatus, wherein the media ok command indicates that the plug-in type apparatus exists currently.

5. The method according to claim 4, wherein before the sending the inquiry command, the method further comprises:
performing detection identification on the plug-in type apparatus.

6. A driving device, comprising:
a receiving unit, configured to receive an inquiry command sent by a host, wherein the inquiry command is used to inquire whether a plug-in type apparatus exists;
a determining unit, configured to determine, according to the inquiry command received by the receiving unit, whether the plug-in type apparatus exists;
a processing unit, configured to send a media ok command to the host when the determining unit determines that the plug-in type apparatus exists, wherein the media ok command is used to notify the host that the plug-in type apparatus exists currently, so that the plug-in type apparatus performs data exchange with the host; and send a media change command to the host when the determining unit determines that the plug-in type apparatus does not exist, wherein the media change command is used to notify the host that the plug-in type apparatus does not exist currently.

7. The driving device according to claim 6, further comprising an accepting unit, wherein
the accepting unit is configured to accept detection identification of the host.

8. A communication apparatus, comprising:
a sending unit, configured to send an inquiry command, so as to trigger a driving device, to determine whether a plug-in type apparatus exists, wherein the inquiry command is used to inquire whether the plug-in type apparatus exists; and
a processing unit, configured to, when the driving device determines that the plug-in type apparatus does not exist, receive a media change command sent by the driving device, wherein the media change command indicates that the plug-in type apparatus does not exist currently; and when the driving device determines that the plug-in type apparatus exists, receive a media ok command sent by the driving device and perform data exchange with the plug-in type apparatus, wherein the media ok command indicates that the plug-in type apparatus exists currently.

9. The communication apparatus according to claim 8, further comprising an identification unit, wherein
the identification unit is configured to perform detection identification on the plug-in type apparatus.
